(19) United States
(12) Patent Application Publication
(10) Pub. No.: US 2009/0248348 A1
(43) Pub. Date: Oct. 1, 2009

(54) Reducing Test Time By Downloading Switching Sequences To An Enhanced Switch Unit

(75) Inventors: Kah Khim Wee, Bayan Lepas (MY); Choo Khiam Loo, Bayan Lepas (MY)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(73) Assignee: AGILENT TECHNOLOGIES, INC., Loveland, CO (US)

(21) Appl. No.: 12/058,766

(22) Filed: Mar. 31, 2008

(51) Int. Cl. G01M 19/00

(52) U.S. Cl. 702/122

(57) ABSTRACT

Reducing overall test time taken in modular electronic test equipment via a network by downloading switching sequences of a test sequences to a switch unit. Examples of electronic test equipment networks are PXI, VXI, LXI and GPIB. Latency encountered during communication between a controller and a switch unit can delay the completion of a test sequence. By downloading the switching sequences of the test sequence to the switch unit and allowing the switch unit to control the switching sequences of relays, latency between the controller and the switch unit is greatly reduced. A switching action is incremented with the switch unit receives a trigger signal. The trigger signal can be sent from the controller or the test equipment. The trigger signal can be sent via additional wiring and is independent of the network.

### BACKGROUND OF THE INVENTION

Modular electronic instrumentation platforms are used as a basis for building electronic test instruments or automation systems. Such platforms are used in a mobile phone manufacturing or automotive electronic testing.

RS-232, General Purpose Interface Bus (GPIB), PCI extensions for Instrumentation (PXI), and VME extensions for Instrumentation (VXI) have been the primary interfaces (networks) for connecting the electronic test equipment to Personal Computer (PC) workstations in test and measurement applications.

Local Area Network (LAN) connectivity is an alternative interface for automating and controlling test and measurement equipment. With test equipment connected to a LAN, multiple users can control the equipment from multiple locations, giving the ability to collaborate with worldwide teams, consult with colleagues in different locations, collect data, perform measurements, share results or monitor the progress of tests.

LAN extensions for Instrumentation (LXI) is a test system architecture based on Ethernet standards. LXI enables fast, efficient, cost-effective creation and reconfiguration of test systems. It also enables connectivity that is longer than 6 meter, which is not feasible in a GPIB network.

FIG. 1 illustrates a typical setup 101 for an electronics testing network. A controller 103 stores testing sequences for the Device Under Test (DUT) 111. The controller 103 is connected to a router 105. The router enables equipment in a laboratory or on a test floor to be connected together in a network and linked to the controller 101, for example via LXI. Connected to the router 105 are test equipment 1 to N 109. Examples of the test equipment 109 are a Digital Multimeter, a Digitizer (“measuring instrument”) and an Arbitrary Waveform Generator (“signal generating instrument”). Also connected to the router 105 is a Switch Unit (SU) 107.

The SU 107 can be used for switching instrumentation, for example switching a signal path of signal generating instrument and measuring instruments, to the DUT 111. Relays enable the SU 107 to perform the switching functions.

Cables from the signal generating instrument and probes from the measuring instrument are connected to the DUT 111 via a switch matrix in the SU 107. A switching path is a signal path taken from the signal generating instrument to the DUT 111 and onward to a measuring instrument.

The test sequence comprises switching sequences and measurement instructions. The switching sequences create switching paths while the measurement instructions instruct the equipment 109 to perform measurements.

The test sequence is executed from the controller 103. The switching sequences are sent to the SU 107 by the controller 103. The switching sequences identify which relays to activate or deactivate. The measurement instructions are sent to the equipment 109 by the controller 103 after the switching path is set.

When testing a DUT, the controller will send specific instructions to the SU 107 or the equipment 109—the former to establish a switching path and the later to execute measurements.

Round-trip latency refers to the total time taken for the controller 103 to transmit an instruction and for a destination system to response to that instruction received. Round trip latency excludes the amount of time the destination system spends processing the instruction. For example, the average round-trip latency of the test equipment 109 over a GPIB interface is 300 μs. The setup 101 based on a VXI-11 protocol typically has a round-trip latency of 2-3 ms. The setup 101 based on an LXI interface therefore has a round-trip latency greater than the setup 101 with a GPIB interface.

A switching sequence comprises sending instructions to a relay driver to actuate a number of relays. A typical relay takes approximately 500 μs to settle and incurs a round-trip latency of 2-3 ms for LXI based systems. The relays comprise a matrix of switches, for example mechanical relays, to enable a switching path. The relays can be a stand-alone unit external to the SU 107.

Latency is a significant impediment to a test system in the electronics test industry, especially the automotive electronics test industry. Switching sequences can attribute approximately 85% of a test sequence. For a complex DUT 111, it is typical to have a test sequence with switching sequences exceeding 1000 switching paths. A latency of 2 ms for each switching path will result in 2 seconds of additional test time. This additional test time can be a determining factor in selecting a competitor's test system, thereby resulting in potential losses for businesses.

Reducing latency by downloading the switching sequences to the SU was deemed unfeasible, as the SU is not designed to store and execute the switching sequences locally by itself. The SU is designed to activate a switching path upon receiving each instruction from the controller 103.

Accordingly, a need exists to reduce the latency observed in the electronics testing network setup 101 to quicken the overall time taken to test a device.

### BRIEF DESCRIPTION OF THE DRAWINGS

FIG. 1 is a drawing of a setup for an automated electronic test system commonly used in the art;

FIG. 2 is a block diagram of an enhanced switch unit;

FIG. 3 is a flow chart describing the operation of the enhanced switch unit; and

FIGS. 4A-B are network drawings for automated electronic test systems using the enhanced switch unit.

### DETAILED DESCRIPTION

The solution presented herewith reduces the round-trip latency for each switching sequence sent by the controller 103 to the switch unit 107. The switch unit 107 is replaced with a switch unit enhanced with features comprising a significant size of flash memory, additional digital logic control circuits, and an algorithm to automate the switching execution process. The additional features of the enhanced switch unit (ESU) enable the controller 103 to store the switching sequences to the ESU before testing commences. Executing the switching sequences is undertaken by the ESU.

The ESU can be designed as stand-alone units that provide the necessary features described above. For example, the ESU can comprise a processor unit, a memory unit to store the switching sequences for a complete test of a particular DUT 111, and the switch unit 107. The switch unit 107 can have relays as part of the switch unit or as stand-alone units.

An aspect of the invention is to download the switching sequences of the test sequence to the ESU. An internal sequence counter in the ESU advances the switching sequences when the trigger signal (described above) is received from the controller 103 or the equipment 109. The round-trip latency incurred by setting each switching path in the switching sequence (“a switching action”) is greatly reduced as the entire switching sequence is stored in the ESU.

Another aspect of the invention is a trigger input and output of the ESU for sending and receiving a trigger signal. A trigger signal received at the ESU can be used to increment the switching sequence. In addition to receiving the trigger signal via the network interface inputs, the trigger can be sent on a connection other than the network the elements are connected to. Using this aspect of the invention, a trigger signal can be sent to the ESU instructing the ESU to increment its sequence counter and to respond with an acknowledgement.

Using a different wiring topology, the ESU can receive a trigger signal from the test equipment to proceed to next switching sequence when measurement is done, without having to first send a message to the controller. The ESU can then trigger the controller to proceed to next measurement. The trigger signal may contain very little information and can be as simple as a short pulse spanning the nanosecond range.

Consequently, when communicating using the trigger signal, the latency is further minimized. The time saved goes towards reducing the overall test time. Furthermore, by minimizing communication between the controller 103 and the ESU for each switching action, the test sequence can be completed in a shorter time.

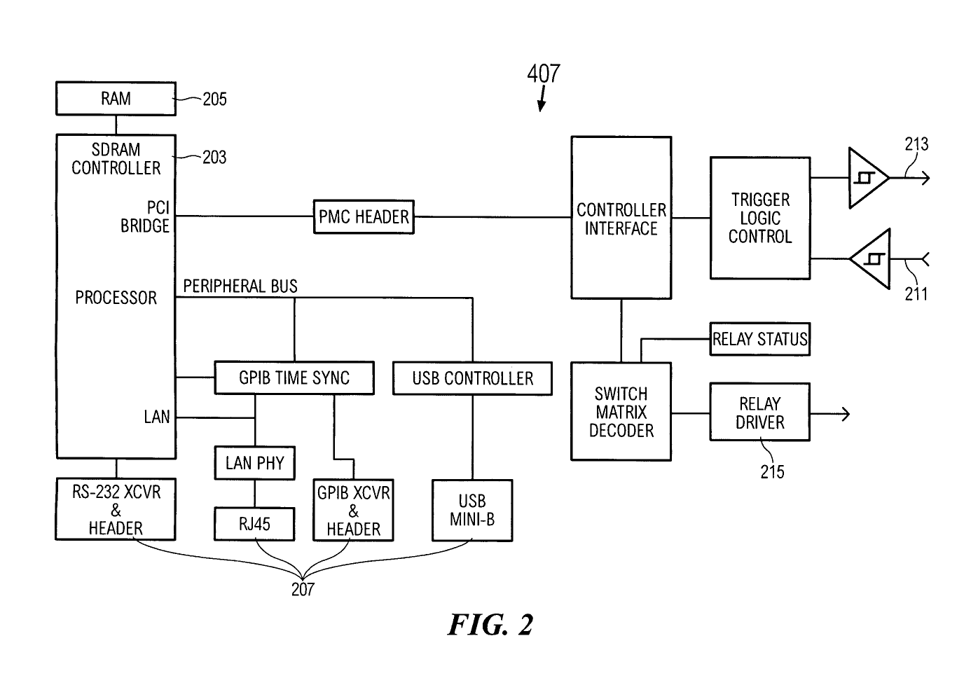

FIG. 2 is a block diagram illustrating the components that comprise an ESU 407. The block diagram describes a Computer Readable Media (CRM) 205 containing code for providing instructions to and for execution by the ESU 407. The CRM 205 can be, for example a ROM, a RAM, a hard drive, or other computer readable media known in the art.

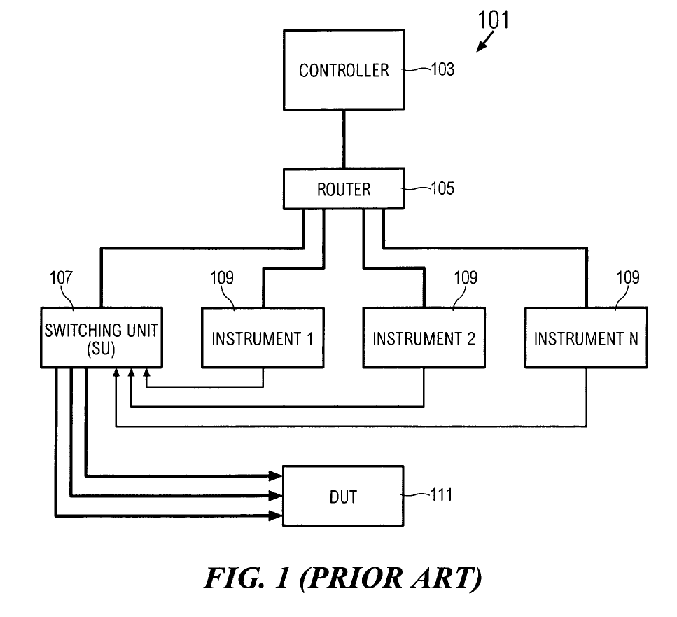

A processor 203 interfaces with the CRM 205 and several types of network interface inputs 207. The switching sequences from the controller 103 (FIG. 1) are sent via the network interface inputs 207 and stored onto the CRM 205 by the processor 203.

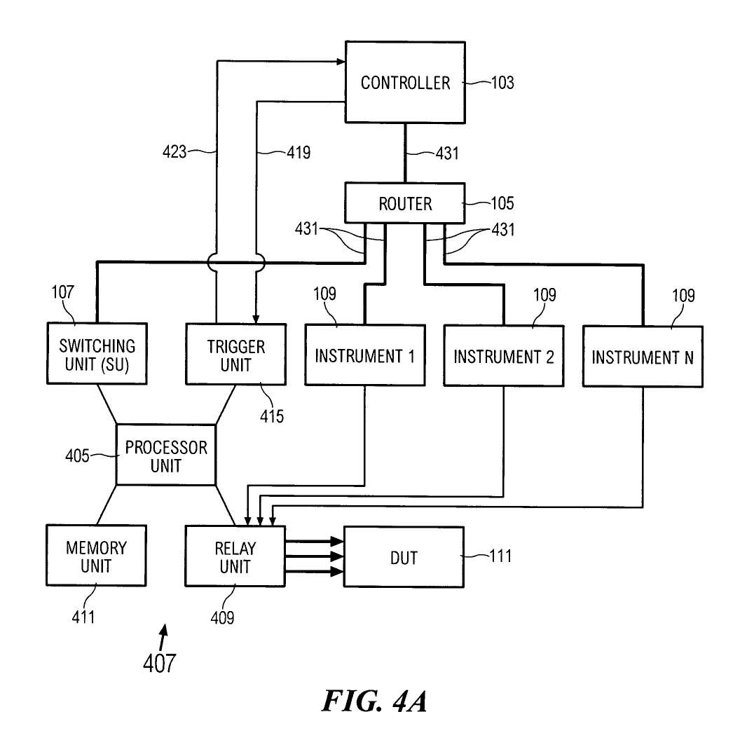

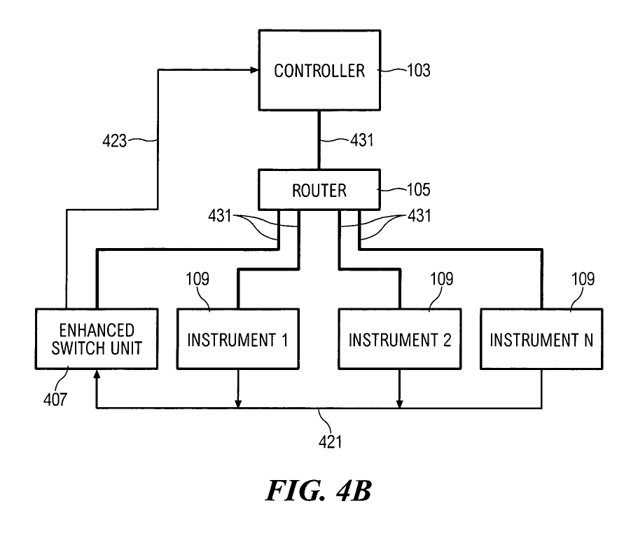

In addition to receiving the trigger signal via the network interface inputs 207, the processor 203 can also accept the trigger signal from a trigger-in port 211. Likewise, the ESU 207 sends a trigger signal through the trigger-out port 213. The trigger-in and out ports can be connected to the equipment 109 (FIG. 1) or the controller 103 to trigger a follow-up sequence. The trigger-in and out ports require additional wiring and is discussed in FIG. 4.

When the processor 203 executes a switching action, relays are energized by a relay driver 215. The relays (not shown) can be located within the ESU 407 or reside as a separate unit.

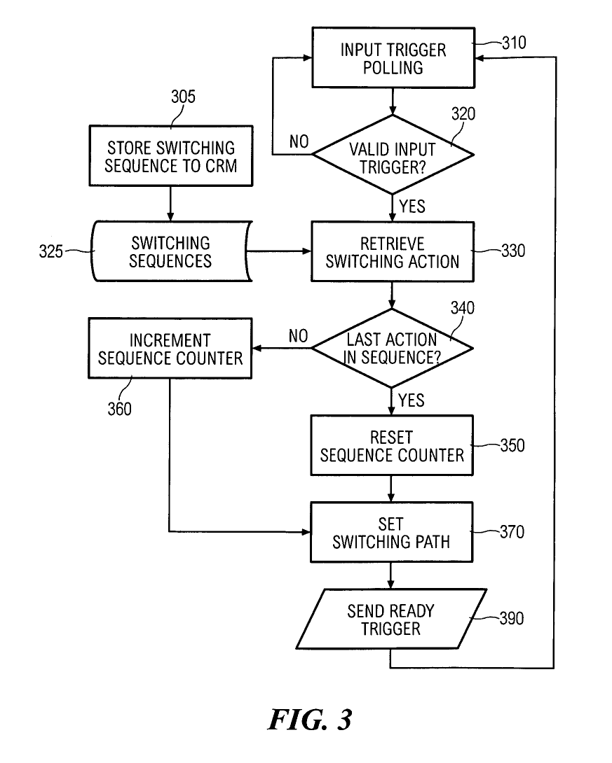

FIG. 3 is a flow chart detailing steps taken by the ESU 407. These steps are a part of executable code. The code can reside within the CRM 205 (FIG. 2) and is used by the processor 203.

Block 305 describes storing the switching sequence from the controller 103 to the CRM 205 of the ESU 407.

In Block 310, the processor 203 monitors for a valid trigger signal. A trigger signal can be sent from either the controller 103 or the equipment 109. If a valid trigger signal is received (Block 320), the processor 203 will then retrieve a switching action (Block 330) from the switching sequences. Block 325 describes the switching sequences having been pre-stored in the CRM 205 from the controller 103.

The CRM 205 can store more than one switching sequence. Each switching sequence is identified by an identity number. The required switching sequence is verified by the test sequence before testing commences.

In Block 340, the processor 203 will determine if the switching sequence has reached its last switching action. If the last switching action is detected, the processor 203 will then reset the internal sequence counter (Block 350) to return to the beginning of the switching sequence in preparation of the next DUT 111. Otherwise, the processor 203 will increment the internal sequence counter (Block 360) to point to the next switching action in the switching sequence.

In Block 370, the switching path information is sent to the relay driver 215. The relay driver 215 interfaces with a relay unit to turn on or off a number of switches to enable a switching path.

In Block 390, a trigger signal is sent by the ESU 407 to acknowledge that the required switching path is set. The trigger signal can be sent to the controller 103 to proceed with next instruction in the test sequence. Alternatively, the trigger sent in Block 390 can be substituted by a measured delay, whereat the next task in the test sequence proceeds automatically.

The flow returns to Block 310 wherein it polls for another valid trigger signal.

FIGS. 4A and 4B are network layout drawings illustrating the electronic testing network using the ESU 407. In FIGS. 4A-B, the controller 103, the test equipment 1 to N 109 and the ESU 407 are connected to the router 105 via cable wiring 431, for example RJ-45 cables. The DUT 111 is also connected to the ESU 407 and indirectly to the test equipment 109 via the ESU 407.

FIG. 4A describes the ESU 407 as stand-alone units comprising the switch unit 107, a processor unit 405, a CRM unit 411, a trigger unit 415, and a relay unit 409. The processor unit 405, trigger unit 415, and the CRM unit 411 perform functions similar to those described in FIG. 2. The relay unit 409 is a unit comprising a matrix of switches, for example electrical or mechanical relays, to enable a switching path. These units are interfaced to the SU 107 to enable the switch unit 107 to perform as the ESU 407.

FIG. 4A illustrates wired connections 423 and 419 between the trigger unit's 415 the trigger-in port 211 (FIG. 2), the trigger-out port 213 (FIG. 2) and the controller 103. The wired connections 419 and 423 enable a controller-triggered response system within the testing network.

In the controller-triggered response system, the controller 103 triggers (Block 310) the ESU 407 to increment to the next switching sequence (Block 360 of FIG. 3). The request is sent through the wired connection 419 and received at the trigger-in port 211 (FIG. 2) of the trigger unit 415. The ESU 407 can send a trigger signal (Block 390) through the wired connection 423 to the controller 103 when the switching path is established (Block 370). Subsequently, the controller 103 can send measurement instructions to the equipment 109 through the network.

The sending of trigger signals through wired connections 423 and 419 reduces latency in communication between the controller 103 and the ESU 407 when setting the switching path.

In FIG. 4B, additional wiring 421 connects the equipment 109 to the trigger-in port 211 (FIG. 2) of the ESU 407. The separate wire 423 connects the trigger-out port 213 (FIG. 2) of the ESU 407 to the controller 103. The additional wiring 421 and wire 423 enable an instrument-triggered response system within the testing network.

In an instrument-triggered response system, when the equipment 109 completes a measurement, the equipment 109 will trigger the ESU 407 to proceed to the next action in the switching sequence. The ESU can receive the trigger signal from the test equipment 109, by way of the additional wiring 421, to proceed to next switching sequence when measurement is done. This avoids having the test equipment 109 send a specific instruction to the controller 103. This further minimizes communication between the controller 103 and the ESU 407 after each action in a switching sequence, and goes towards reducing latency and the overall time taken to test a DUT.

While the embodiments described above constitute exemplary embodiments of the invention, it should be recognized that the invention can be varied in numerous ways without departing from the scope thereof. It should be understood that the invention is only defined by the following claims.

1. A system for controlling electronic test equipment via a network, comprising:
a switch unit;
a controller for storing a switching sequence to the switch unit and for sending measurement instructions to the electronic test equipment connected via the network; and
a trigger input of the switch unit for receiving a trigger signal and for incrementing the switching sequence in response to the trigger signal.

2. The system of claim 1, wherein the trigger signal is sent from the electronic test equipment or the controller to the switch unit.

3. The system of claim 1, further comprising a first wire, the first wire connecting the trigger input to the controller or the equipment, such that the trigger signal sent to the switch unit is sent on the first wire.

4. The system of claim 1, further comprising a trigger output of the switch unit for sending the trigger signal.

5. The system of claim 4, further comprising a second wire, the second wire connecting the trigger output and the controller, such that the trigger signal sent by the switch unit is sent on the second wire.

6. The system of claim 1, further comprising relays connected to the switch unit, the relays being actuated by instructions sent from the switch unit.

7. The system of claim 1, wherein the network is an LXI network.

8. The system of claim 1, wherein the switch unit comprises a processor.

9. The system of claim 1, wherein more than one switching sequence is stored to the switch unit, each switching sequence being identified by an identity number.

10. A method of controlling electronic test equipment via a network, comprising:
receiving a switching sequence at a switch unit;
storing the switching sequence to the switch unit;
sending a trigger signal to the switch unit to increment the switching sequence; and
sending measurement instructions to the electronic test equipment.

11. The method of claim 10, wherein the trigger signal to the switch unit is sent by a controller or the electronic test equipment.

12. The method of claim 10, the step of sending a trigger signal to the switch unit to increment the switching sequence further comprises the step of sending the trigger signal over a first wire, the first wire connecting the trigger input to a controller or the electronic test equipment.

13. The method of claim 10, further comprising the step of sending the trigger signal from the switch unit to a controller after the switch unit has incremented the switching sequence.

14. The method of claim 13, the step of sending the trigger signal from the switch unit to a controller after the switch unit has incremented the switching sequence, further comprising the step of sending the trigger signal over a second wire, the second wire connecting the trigger output to the controller.

15. The method of claim 10, wherein storing the switching sequence to the switch unit comprises the step of storing the switching sequence to a computer readable media, the computer readable media being part of the switch unit.

16. The method of claim 15, further comprising the step of the switch unit retrieving from the computer readable media a switching action, the switching action being part of the switching sequence.

17. The method of claim 16, further comprising the step of setting a switching path using relays, the relays controlled by the switch unit, the switching path being determined by the switching action.

18. The method of claim 10, further comprising the step of resetting a sequence counter upon reaching a last action in the switching sequence.

19. The method of claim 10, wherein the testing network is an LXI network.

20. The method of claim 10, further comprising the steps of storing more than one switching sequence to the switch unit, each switching sequence being identified by an identity number, and verifying a switching sequence before testing commences.
